(19) United States
(12) Patent Application Publication
(10) Pub. No.: US 2003/0088661 A1
(43) Pub. Date: May 8, 2003

(54) Method for constructing distributed software components

(76) Inventor: Henricus Bernardus Maria Jonkers, Eindhoven (NL)

Correspondence Address: U.S. Philips Corporation, 580 White Plains Road, Tarrytown, NY, 10591, US

(21) Appl. No.: 10/280,648

(22) Filed: Oct. 25, 2002

(30) Foreign Application Priority Data
Oct. 30, 2001 (EP) 01204139.8

(51) Int. Cl. G06F 15/173

(52) U.S. Cl. 709/223

(57) ABSTRACT

A method for exchanging data between two or more program threads running on one or more computing devices each including a processor and at least some memory, said method comprising the following steps:

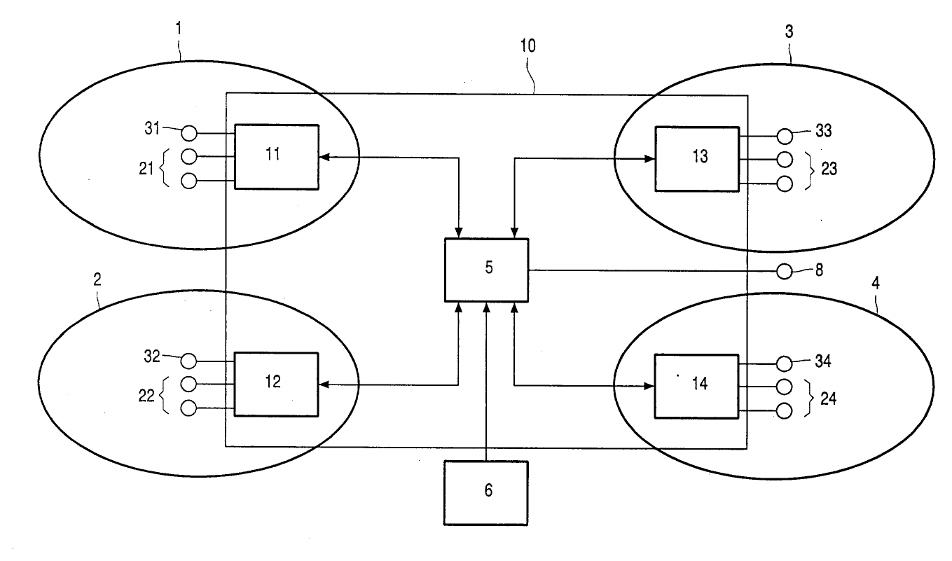

a first of said program threads executes a contractual software component for defining a relation between said threads;

said first program thread and one or more second program threads each create respective contractual software objects on the basis of the defined relation of said contractual software component.

Computing devices are becoming more and more interconnected by the increasing use of computer and communication networks. Furthermore, more and more devices, such as audio and video equipment, domestic appliances (mobile) telephones, etc. are comprising computing means for running software. These appliances also tend to be connected to communications networks. In order for software to be able to communicate to other software, either running on the same device or running on another device over a communications network, the way that the software communicates has to be defined. Many ways of defining such communications have been devised in the past. A reason for such diverse ways of communication of software is that the said diversity of appliances running software originates from a multitude of industries.

Even within the industry of computing a great variety of ways of communication between software has been developed. Considering that appliances from the above mentioned other industries, such as domestic appliances, telecommunications, etc., also have their own history of ways of software communication, it is not surprising that in order to create a working system for communications between appliances many ad hoc solutions have been developed. A result of this development is that it is unlikely that two or more software components that are used in equipment of the prior art are capable of communicating properly. In order to overcome this software problem patches are created whenever two or more software components need to intercommunicate. Developing such ad hoc patches is very costly.

In order to overcome such disadvantages the present invention provides a method for exchanging data between two or more program threads running on one or more computing devices each including a processor and at least some memory, said method comprising the following steps:

a first of said program threads executes a contractual software component for defining a relation between said threads;

said first program threads and one or more second program threads each create respective contractual software objects on the basis of the defined relation of said contractual software component.

The contractual software objects (co-clients) together with the relation (initial co-object) may reside in one or more devices and behave as a single logic entity. An advantage hereof is that the use of such components enable software to communicate at a high level on top of standard networking and/of communication technology. A second advantage hereof is that for software to communicate with each other, existing networks and network software can be used on top of which the distributed co-objects of the software are operative.

Another advantage of this invention is that in order for software to communicate using such distributed components, which work the same for every program thread, it is no longer needed to program an ad hoc code for threads to be capable of communicating. After a certain role is chosen, the distributed component will behave according to role functions, which is explained further in the description of the drawings.

Furthermore, the current invention provides a systematic way of controlling network traffic (round trip control). Using this method an implementation of a distributed software component can be optimized depending on network latencies and a degree of distribution, without the need to introduce special interfaces. For optimizing an implementation of a distribution of the component to a network, network topology can be taken into account while no adjustments of interfaces are necessary.

Another advantage of this method is that the behavior of a distributed component is independent of its degree of distribution. Although there will always be differences at the performance level, using the method according to the invention enables a full prediction of the way the communication between program threads is executed.

In a preferred embodiment of the invention, the defined relation between said threads is an instantiation (initial co-object) of the contractual software component. One or more contractual software objects (co-clients) together with a (set of) defined relation between threads as a whole (a co-component) is a software component that is used by the program threads for creating co-clients. The relation defines how program threads have to create a co-client as co-clients run in the program space or domain of program threads.

In a further preferred embodiment of the invention, for every program thread a contractual software object (co-client) is created using a method according to the above, for exchanging data by allocating the necessary means for creating and operating said co-clients.

The initial co-object is a definition of contractual terms, which program threads have to underwrite in order to make use of a co-object for exchanging data with other program threads. A contract identifies roles. If a program thread needs the use of such roles, the program thread can “sign” for that role. A role implies “rights” and “obligations”. These rights and obligations comprise the allocation of means for creating and operating a co-client.

Program threads will have to reserve means for the use of co-clients. The specification of the means to be reserved for this are laid out by the co-object in the initial co-object. If a program thread needs the use of the distributed software component it will underwrite the so-called contract with the effect that a co-client is created according to the specification of the role for which the client signed.

In a further preferred embodiment of the invention the distributed co-object is a single logic object.

Furthermore, it is preferred that a program thread operates locally on a first contractual software object for communicating data to a second thread by means of a second contractual software object of the latter. An advantage hereof is that, as the co-client runs locally within the thread, that in order for a thread to communicate to another thread it only needs to perform an internal operation with its co-client. After the thread has internally passed on the data to be communicated to the co-client, the distributed object takes care of the communication of the data to other threads after a “commit”, which will be explained later in the description of the drawings.

It is further preferred that a local operation on said first contractual software object of said single logic object becomes global after a commit operation of said first co-client. When a co-client has received data from its host thread by said internal operation, the data is still stored locally. In order for target co-clients, which are co-clients running within other threads that need to receive the communication, to receive data, the first co-client has to perform a commit operation. By this operation, which is run by the co-object of which the co-client is a part, the target co-clients will be notified that they will receive data. An advantage is that the global operation is carried out by the co-object in a manner that is understandable by other co-clients because the co-objects comprising the co-clients form a single logic object.

It is furthermore preferred that a global operation of said first contractual software object of said single logic object takes effect on a second contractual software object by means of calling a sync operation by said second contractual software object. An advantage hereof is that data that has become global after the commit operation of said first co-client will now become local in the program threads in which the second co-client is running. Hereafter the second thread, that the communication was directed at, will be able to access the data by an internal operation. So it is clear that also at the receiving end of the communication the sync operation is an operation of the co-object, which means that a thread receiving the data does not need to perform global operations in order to access the data. The receiving thread merely needs to perform a local operation on its co-client.

U.S. Pat. No. 6,182,152 (attorney docket PHN 015645) by the same applicant as the present application discloses the use of intraproces update operations and inter-proces adapt operations for synchronizing concurrent sequential processing. In this document a synchronization method is described for processors that are mutually connected by means of “channels”. These “channels” consist of three parts: a part which is local to the sender, a part which is local to the receiver and a global part. In this document, a “COMMIT” operation executes all pending updates of a process automatically. A “SYNC2” operation executes all pending adapt operations of a process. A method according to this document can be executed when all processors are part of the same apparatus and use shared memory.

Another preferred embodiment provides a computer system comprising at least one computing device with at least one processor and one memory running at least two concurring program threads that need to exchange information, for performing a method according to the invention.

In co-pending European patent application serial no. 01204140.6 (attorney docket PHNL010784) a communications protocol is disclosed which makes consistency possible of computations independent of a degree of distribution of the distributed components. Making use of such a method of guaranteeing sequential consistency enables co-working processor to function independently of delays in communications.

Further advantages, features and details of the present invention will be elucidated in the light of the following description of a preferred embodiment thereof with reference to the annexed FIG. which shows a diagram of a preferred embodiment.

A co-object according to the invention is represented as a rectangle 10. The co-object 10 comprises one initial co-object 5 and four co-clients 11, 12, 13, 14. The initial co-object 5 is created by a software component 6 upon a call to do so from a program thread. A co-client is created as a logic part of the co-object 10 when a program thread, which is software running on a computing device (not depicted), needs to exchange data with at least one other program thread.

A co-object is a logic entity wherein the co-clients are created which run in the respective program threads (processes) 1, 2, 3, 4. The co-object and the co-clients enable communication of data between threads in such a way that the threads can hand over data to co-clients within their respective process. The actual sending of the data from one co-client in the sending process to another co-client in the receiving process, i.e. from co-client 1 in process 1 to co-client 2 in process 2, is done outside the scope of the sending process and therefore handled by the co-object. The co-object is responsible for all operations concerning transmission of the data at the global level.

When a process 1 needs to transmit information to another process 2, the process creates a co-client using a co-object. In order to be able to create a co-client the process needs to read data from the initial co-object concerning how this is done. The initial co-object comprises information as to what kind of resources and processing capacity need to be reserved in order to operate the co-client. Based on this information the process can create the co-client. The co-client, thus created, will be running within the resources of the process 1 and will logically be part of the co-object. Also in process 2 a co-client is to be created in a similar manner. A process needs certain functions to be performed. A combination of these functions is called a role. Therefore, the data to be read from the initial co-object or instantiation of the contractual software component enables the process to create a co-client capable of fulfilling the role.

A co-component is a software component which can be embodied as a COM component that contains the implementation of a particular class of co-objects. A co-object is created by creating an initial co-object in the same way as an object of that class. This is done using “CoCreateInstance” if COM is used. In practice, co-objects can be seen as contracts, which means that clients can dynamically sign for a particular role which is identified in a contract and which implies that they get the rights but also the obligations associated with that role.

Therefore, it is necessary for a COM component to have a proper specification identifying the roles and the associated rights and obligations. The specification identifies several interfaces which are associated with the roles. In terms of COM it is preferred that the specification is identified by a Globally Unique ID (GUID) which is referred to as a contract ID instead of giving each interface specified in the contract a separate GUID.

An example of a co-component is an “Event Mediator”. This Event Mediator co-object provides facilities to dynamically connect and disconnect event sources and event sinks. Typically, some event sources and sinks will reside on the same machine while others will be located on different machines.

Three different roles are distinguished for the event mediator. An “event sender” is the owner of an event source. It can connect to and disconnect from the event mediator as an event source for a particular type of event. After connecting, it can report occurrences of the event to the event mediator.

An “event receiver” is the owner of an “event sink”. It can connect to and disconnect from the event mediator as an event sink for a particular type of event. When connecting, the event receiver should specify an event handler for the event type. The effect is that events occurring at the source of the event sender are propagated to the sink of the event receiver (provided that the sender “commits” and the receiver “syncs”). The third role is an “event inquirer” which can query the event mediator for the number of registered sources and sinks for a given event type. Note that this is a simplified example. A practical event mediator would have to have more features.

An initial co-object 5 will be created according to the invention in a standard way of creating an object in a component technology or programming language. A co-object initially comprises only the initial co-object which explains the name “initial co-object”. It remains in existence as long as the co-object exists and its identity is used as the identity of the co-object. The object comprises at least one interface “ICoSign”8 which enables program threads or processors to sign for a particular role. Signing for a role will create a co-client in the domain of the process or client. A co-object may have additional interfaces specific to the co-object.

As described in the above the purpose of an ICoSign 8 is for potential clients of the co-objects to engage in interaction with the co-object in a particular role. A client has to sign for that role which implies that it will have to meet all obligations associated with that role. In return, the client gets services from the co-object. The roles are specified by means of role IDs. After signing and the creation of a co-client respectively in the domain of the client a reference to the co-client is returned to the client. Signing may fail, as indicated by a return value of a sign operation. For example, there may be roles for which only one client may sign. ICoSign only supports “signing up” for a role and not “signing off”. This does not mean that a contract (as represented by the co-object) cannot be cancelled. If a contract can be cancelled, this should be specified as part of the contract itself and be supported by the role-specific interfaces of co-clients. Furthermore, the co-client is meant for use by the signing client only. Calls to methods of the co-client are interpreted by the co-object as coming from the client, which means that the co-client is used by the co-object for identifying the client.

A co-client is a client-side object with a fixed set of interfaces which are a standard interaction interface 31, 32, 33, 34 and a collection of interfaces 21, 22, 23, 24 which are specific to the role associated with the co-client.

When signing up for a particular role, the client gets a private copy of a co-client for that role. The role-specific interfaces of the co-client provide access to the functionality associated with the role. The effect of the operations provided by these role-specific interfaces is strictly local to the process domain of the client.

The local effects of operations on the co-client can be turned into global effects on the co-object by means of the interaction interface. Global effects on the co-object by other clients can be turned into local effects on the co-client by means of this interface as well.

It is to be noted that the set of roles supported by a co-object may vary dynamically, in contrast with the set of interfaces associated with a co-client.

The term “clients” is a general term for the users of co-objects which are the program threads. They interact with the co-object through the interfaces of co-clients only. The co-client for a particular role played by a client is created in the process domain of the client, which means in the same address space as the client.

Notice that the term “client” is a general notion which can in reality be a process, thread, object, group of objects, etc.

An example of a role-specific interface of event receiver co-clients is “IEventReceiverConnect”, as can be specified using COM IDL:

IEventReceiverConnect
{ void connect ( [in] EventID id,

[in] EventHandler hd1
);

void disconnect ( [in]EventID id );
}

This interface allows a client to connect and disconnect as an event receiver by specifying an event ID and an event handler. The effect of a connect operation is that the client will be registered as a receiver of the type of events identified by the event ID. If senders are registered for this type of event, any events raised by these senders will be propagated to the co-client.

Besides an operation to handle events, an event handler interface can also provide two operations to handle the connection and disconnection of the client. A reason for this is that connection and disconnection are asynchronous. The co-object acknowledges connection and disconnection by calling the corresponding event handler operations.

Furthermore, all other role-specific operations, such as the connect and disconnect operations, need to be committed before they have an effect at the co-object level.

The interaction interface provided by each co-client is the primary means to control the intensity of network traffic between the programmed threads that are using the co-object for exchanging information. Each role specific operation by a client on a co-client is strictly local to the process domain of that client and does not involve any network traffic, which is a great advantage of this invention. A global effect of an operation on a co-object is effectuated only after a “commit” operation of the co-client has been executed by the client. Exactly what this effect is should be read from the specification of the co-object.

Committing has a global effect on the co-object but not on any of the other clients using the co-object. It is very advantageous that data can be transmitted by a thread without affecting other threads by doing so. In order for other clients to take the effect of a commit operation a client has to call a sync operation on the co-client, which will cause an effect to occur in the co-client (and that co-client only). The use of a method according to this invention enables interaction to take place at well-defined moments only, which optimizes network traffic.

An example of how a sender can send two types of events, “keyboard events” and “mouse events” can be specified using COM:

Actions by Receiver:

(1) eventReceiver.connect (keybdEventID, eventHandler);

(2) eventReceiver.connect (mouseEventID, eventHandler);

(3) commit ( );

(4) . . . actions by sender . . .

(5) sync ( );

(6)—eventHandler.handleConnect (keybdEventID);

(7)—eventHandler.handleConnect (mouseEventID);

(8)—eventHandler.handleEvent (keybdEventID, shiftKey);

(9)—eventHandler.handleEvent (keybdEventID, ctrlKey);

(10)—eventHandler.handleEvent (mouseEventID, clickLeft);

Initially, the sender has to connect as a sender of keyboard and mouse events by calling a corresponding “connect” operation of the co-client “coEventSender”.

By calling a “commit”, these commands are propagated to the co-object which will enable the client as a sender of the two types of events. From that moment on, the co-object will pass events of these types raised by the sender to receivers of these types of event.

The sender raises three events: “shiftKey”, “ctrlKey” and “clickLeft”. The “raiseEvent” operation has local effects on the sender co-client only. The “commit” will establish the global effect of these operations.

Another example shows how a receiver can receive events that are specified using COM:

Actions by Sender:

(1) CoEventSender.connect (keybdEventID);

(2) CoEventSender.connect (mouseEventID);

(3) commit ( );

(4) . . .

(5) CoEventSender.raiseEvent (keybdEventID, shiftKey);

(6) CoEventSender.raiseEvent (keybdEventID, ctrlKey);

(7) CoEventSender.raiseEvent (keybdEventID, clickleft);

(8) commit ( );

Initially, the receiver has to connect as a receiver of keyboard and mouse events. The “commit” is used to globally communicate the commands.

In response to the two operations, the co-object will send acknowledgements to the receiver, letting the receiver know that from then on it can expect the arrival of keyboard and mouse events.

When a sender has raised an event, immediately after a connection, as described above, after performing a “sync” the receiver will receive three events: two connection events, two keyboard events and one mouse event. These events are raised at the receiver side (as part of the “sync”) by calling the corresponding event handlers.

Furthermore, additional interfaces can be added. These are called the “IcoConnect” interface of co-clients and the “IcoSignal” interface of clients.

The “IcoConnect” interface of a co-client allows a client to subscribe (“connect”) to notifications of a co-client which reports that a co-client is “out of sync”. In subscribing to this interface the client has to provide an “IcoSignal” callback interface which is used by the co-client to “signal” out-of sync events to the client. The client can stop the notification by “disconnecting” from the co-client.

Interaction operators can be defined on sets of co-clients within a process like an individual co-client, a group of co-clients in an individual co-object, or co-clients in a group of co-objects and/or all co-clients in all co-objects. Primitive interaction operators such as “commit” and “sync” on individual co-clients can be combined to more coarse-grained interaction operators that operate on groups of co-clients on the same co-object, groups of co-clients from different co-objects, or even all co-clients in a certain process domain.

Other interaction operators operating on all co-clients in a process comprise “commit”, “sync”, “wait”, “next” and “await (condition)”. These are examples of composite interaction operators that operate at the process level, i.e. simultaneously on all co-clients in a process. The “commit” operator performs “commits” on all co-clients (in reality, it executes only “pending” “commits”). The “sync” operator performs “syncs” on all co-clients that are out of sync. The “wait” operator causes a wait until a co-client is out of sync. The “next” operator performs a “commit” followed by a “sync”. The “await (c)” causes a wait until the condition C becomes true.

If a co-client and a co-object reside in the same process or on the same machine, a shared-memory implementation of the “commit”-“sync” mechanism can be used when communication between co-clients need not go through the co-object but can be short-cut. The signing-up for the first time in a particular role will generally imply downloading of the co-client code.

1. A method for exchanging data between two or more program threads running on one or more computing devices each including a processor and at least some memory, said method comprising the following steps:
a first of said program threads executes a contractual software component for defining a relation between said threads;
said first program thread and one or more second program threads each create respective contractual software objects on the basis of the defined relation of said contractual software component.

2. A method according to claim 1 wherein the defined relation between said threads is an instantiation of the contractual software component.

3. A method according to claim 1 in which for every program thread a contractual software object is created.

4. A method according to claim 1 in which a contractual software object is created for each thread using the method for exchanging data by allocating the necessary means for creating and operating said contractual software object.

5. A method according to claim 1 in which the contractual software object and the relationship between said threads is a single logical object.

6. A method according to claim 1 in which a program thread operates locally on a first contractual software object for communicating data to a second thread by means of a second contractual software object of the latter.

7. A method according to claim 1 in which a local operation on said first contractual software object of said single logical object becomes global after a commit operation of said first contractual software object.

8. A method according to claim 1 in which a global operation of said first contractual software object of said single logic object takes effect on a second contractual software object by means of calling a sync operation by said second contractual software object.

9. A computer system comprising at least one computing device with at least one processor and one memory running at least two concurring program threads that need to exchange information, for performing a method according to claim 1.

10. A computer program arranged to cause a processor to perform the method of claim 1.
